(19) United States
(12) Patent Application Publication
(10) Pub. No.: US 2010/0170642 A1
(43) Pub. Date: Jul. 8, 2010

(54) Combined Type Screen

(76) Inventor: Ching-Hui CHEN, Dongguan (CN)

Correspondence Address: Jackson Intellectual Property Group PLLC, 106 Starvale Lane, Shipman, VA, 22971, US

(21) Appl. No.: 12/541,924

(22) Filed: Aug. 15, 2009

(30) Foreign Application Priority Data
Jan. 5, 2009 (CN) 200920049640.6

(51) Int. Cl. E06B 3/48

(52) U.S. Cl. 160/113

(57) ABSTRACT

A combined type screen comprises more than one screen boards being connected laterally, characterized in that the combined type screen is formed by more than one layer of screen boards being connected vertically; the top or the bottom of each layer of screen boards, or both the top and the bottom of each layer of screen boards, is provided with several pin holes; the pin holes at the top of a lower layer of screen boards are corresponding to the pin holes at the bottom of an upper layer of screen boards; adjacent two layers of screen boards are connected by pins being inserted into the pin holes. The board face at the side of the pin holes can be provided with a screw hole; after an upper layer and a lower layer of screen boards are connected by the pins, the pins can be fastened by screws. The pins can also be provided with notches, and the notches are corresponding to the screws. The top or the bottom of the screen boards can be provided with locating holes, and the locating holes at the upper layer of screen board are corresponding to the locating holes at the lower layer of screen boards; two locating holes can be connected by locating pins. The height of the screen can be combined optionally to meet different using requirements to the screen; moreover, the height of the screen can be divided into multiple sections, so as to be good for storage and transport.

### BACKGROUND OF THE INVENTION

1. Field of the Invention

The present invention relates to the technical field of interior decoration, particularly relates to a combined type screen, of which the height can be combined.

2. Description of the Related Art

A screen is a decoration for dividing the indoor space, which is formed by several screen boards being connected laterally. According to the different functions of screens, some are only as high as half the height of a man, and others can extend to the ceiling; but the height of conventional screen boards is unchangeable, which obviously can not meet the requirement in height; and the one-section type screen with unchangeable height is not convenient for transport and storage.

### SUMMARY OF THE INVENTION

The object of the present invention is to provide a combined type screen, of which the height can be combined.

The technical solution of the present invention to solve the technical problem is that: the present invention comprises more than one screen boards being connected laterally, characterized in that the combined type screen is formed by more than one layer of screen boards being connected vertically; the top or the bottom of each layer of screen boards, or both the top and the bottom of each layer of screen boards, is provided with several pin holes; the pin holes at the top of a lower layer of screen boards are corresponding to the pin holes at the bottom of an upper layer of screen boards; adjacent two layers of screen boards are connected by pins being inserted into the pin holes. While combining the combined type screen, first insert the pins into the pin holes of a certain layer of screen boards, and then the pin holes of the layer of screen boards to be combined are connected to the pins. To fasten the connection, the board face at the side of the pin holes can be provided with a screw hole; after an upper layer and a lower layer of screen boards are connected by the pins, the pins can be fastened by screws. To fasten the pins more firmly, the pins can be provided with notches, and the notches are corresponding to the screws. To eliminate the lateral movement between an upper layer and a lower layer of screen boards, the top or the bottom of the screen boards can be provided with locating holes, and the locating holes at the upper layer of screen board are corresponding to the locating holes at the lower layer of screen boards; two locating holes can be connected by locating pins. To make the combined type screen beautiful, the lowest layer of screen boards can be provided with screen feet extending out from the bottom of the screen boards; the most upper layer of screen boards can be provided with decorative convex edges.

The beneficial effects of the present invention are that: the height of the screen can be combined optionally to meet different using requirements to the screen; moreover, the height of the screen can be divided into multiple sections, so as to be good for storage and transport.

### BRIEF DESCRIPTION OF THE DRAWINGS

Hereinafter, the present invention is described detailedly with reference to the accompanying figures.

FIG. 1 is a structure schematic diagram of the screen boards of the bottom layer of the present invention;

FIG. 2 is a structure schematic diagram of the screen boards of the middle layer of the present invention;

FIG. 3 is a structure schematic diagram of the screen boards of the top layer of the present invention;

FIG. 4 is a sectional view of the A part of FIG. 1; and

FIG. 5 is an enlarged view of the B part in FIG. 2.

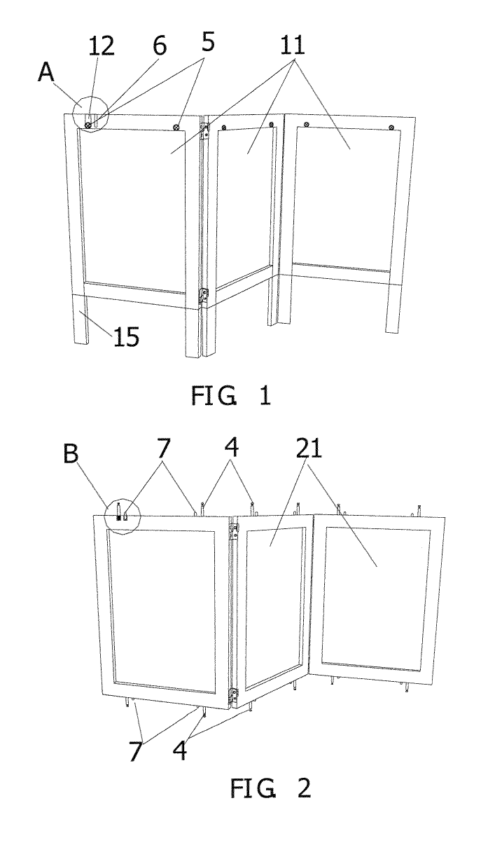

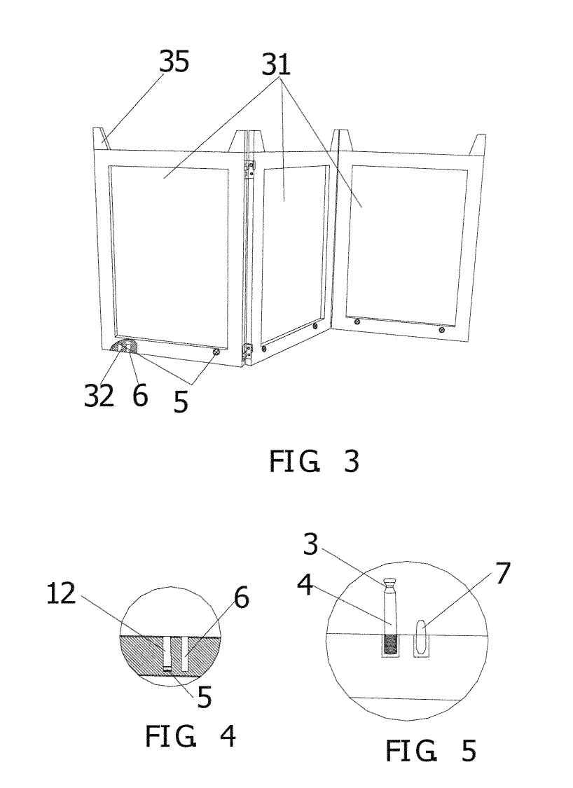

In the figures, 11, 21, and 31 represent screen boards; wherein, 11 represents the bottom layer screen boards; 21 represents the middle layer screen boards; 31 represents the top layer screen boards; 12, 22, 23, and 32 represent pin holes; 4 represents pins; 5 represents screws; 6 represents locating holes; 7 presents locating pins; 15 represents the screen foot; 35 represents the convex edge.

### DESCRIPTION OF THE PREFERRED EMBODIMENT

Referring to the accompanying figures, the present invention comprises more than one screen boards (such as the screen boards 11) being connected laterally (generally being connected by hinge joint), characterized in that the screen is formed by more than one layer of screen boards 11, 21, 31 being connected vertically; the top of the screen boards (such as the bottom layer screen boards 11) or the bottom of the screen boards (such as the top layer screen boards 31), or both the top and the bottom of the screen boards (such as the middle layer screen boards 21) is provided with several pin holes 12, 22, 23, 32; the pin holes 12, 23 at the top of a lower layer of screen boards are corresponding to the pin holes 22, 32 at the bottom of an upper layer of screen boards; the upper layer of screen boards are connected to the lower layer of screen boards by pins 4 being inserted into the pin holes. In an embodiment of the present invention, the side of the pin holes 12, 22, 23, 32 is provided with screw holes; after the upper layer of screen boards and the lower layer of screen boards are connected by pins 4, the pins 4 are fastened by screws 5. Moreover, the pins 4 are provided with notches 3, and the notches 3 are corresponding to the screws 5. In an embodiment of the present invention, each layer of screen boards is provided with more than one locating holes 6, and the locating holes 6 at the upper layer of screen boards are corresponding to the locating holes 6 at the lower of layer screen boards; the locating holes 6 at the upper layer of screen boards and the locating holes 6 at the lower layer of screen boards are connected by locating pins 7. In the present invention, the lower part of the bottom layer screen boards 11 is provided with screen feet 15 extending out from the bottom of the screen boards; the top layer screen boards 31 are provided with decorative convex edges 35. While combining the screen boards, multiple combination modes can be used: the combination can be the bottom layer screen boards 11, one or multiple layers of middle layer screen boards 21, and the top layer screen boards 31; the combination can also be the bottom layer screen boards 11 and the top layer screen boards 31; or the combination can be several layers of middle layer screen boards 21; or the combination can be the bottom layer screen boards 11 and the middle layer screen boards 21; or the combination can be the middle layer screen boards 21 and the e top layer screen boards 31.

What is claimed is:

1. A combined type screen comprising more than one screen boards being connected laterally, characterized in that the combined type screen is formed by more than one layer of screen boards (11, 21, 31) being connected vertically; the top or the bottom of each layer of screen boards, or both the top and the bottom of each layer of screen boards, is provided with several pin holes (12, 22, 23, 32); the pin holes (12, 23) at the top of a lower layer of screen boards are corresponding to the pin holes (22, 32) at the bottom of an upper layer of screen boards; adjacent two layers of screen boards are connected by pins (4) being inserted into the pin holes.

2. The combined type screen of claim 1, wherein the screen boards (11, 21, 31) are provided with more than one locating holes (6), and the locating holes (6) at the upper layer of screen boards are corresponding to the locating holes (6) at the lower layer of screen boards; the locating holes (6) at the upper layer of screen boards and the locating holes (6) at the lower layer of screen boards are connected by locating pins (7).

3. The combined type screen of claim 1, wherein the side of the pin holes (12, 22, 23, 32) is provided with screw holes; after the upper of layer screen boards and the lower layer of screen boards are connected by the pins (4), the pins (4) are fastened by screws (5).

4. The combined type screen of claim 3, wherein the screen boards (11, 21, 31) are provided with more than one locating holes (6), and the locating holes (6) at the upper layer of screen boards are corresponding to the locating holes (6) at the lower layer of screen boards; the locating holes (6) at the upper layer of screen boards and the locating holes (6) at the lower layer of screen boards are connected by locating pins (7).

5. The combined type screen of claim 1, wherein the lower part of the bottom layer screen boards (11) is provided with screen feet (15) extending out from the bottom of the screen boards; the top layer screen boards (31) are provided with decorative convex edges (35).
